(19) United States
(12) Patent Application Publication
(10) Pub. No.: US 2010/0236493 A1
(43) Pub. Date: Sep. 23, 2010

(54) BIRDCAGE

(76) Inventor: Polly Kazakoff, Vernon (CA)

Correspondence Address: Antony C. Edwards, P.O. Box 26020, Westbank, BC, V4T 2G3, CA

(21) Appl. No.: 12/382,500

(22) Filed: Mar. 18, 2009

(51) Int. Cl. A01K 31/06; A01K 31/04

(52) U.S. Cl. 119/462; 119/459

(57) ABSTRACT

The base of a birdcage includes a cartridge or enclosed perforated container having a plurality of balls sandwiched between a pair of screens on either side of the container for providing a decorative and camouflaging base surface for capturing bird excrement and which may be easily cleaned.

### FIELD OF THE INVENTION

This invention relates to the field of birdcages in general, and in particular to birdcages adapted to hold, and which contain in the base of the cage, a cartridge or enclosed perforated container having a plurality of balls sandwiched between a pair of screens on either side of the container for providing a decorative and camouflaging base surface for capturing bird excrement and which may be easily cleaned.

### BACKGROUND OF THE INVENTION

The problem with many conventional birdcages is that the bottom of the cage becomes fouled with bird excrement, partially eaten food, seed husks and the like causing an unsightly mess. Quite often in applicant's experience the bottom of a birdcage will be formed as a tray and will be lined with old newspaper or like disposable lining by the owner of the cage.

In the prior art applicant is aware of numerous patents directed to birdcages and the like having various removable trays, funnels, conveyors and other devices for handling pet excrement generated by pets contained within the cage, in particular:

U.S. Pat. No. 3,672,332 which issued to MacLeod et al. on Jun. 27, 1972 for a Disposable Floor Dispenser for Bird Cage, U.S. Pat. No. 3,815,549 which issued to Opmeer on Jun. 11, 1974 for a Split Level Bird Cage, U.S. Pat. No. 4,009,685 which issued to Sojka on Mar. 1, 1977 for a Method and Apparatus for Handling Wastes from Small Animal Cages, U.S. Pat. No. 4,011,837 which issued to Ksioszk on Mar. 15, 1977 for a Self-Cleaning Animal Kennel, U.S. Pat. No. 4,181,612 which issued to Trail on Jan. 1, 1980 for an Apparatus for Servicing a Bird Cage, U.S. Pat. No. 4,235,196 which issued to Moliterni on Nov. 25, 1980 for a Bird Feeder, Cage and Bag Assembly, U.S. Pat. No. 4,572,107 which issued to Clarizo on Feb. 25, 1986 for an Easily Cleanable Animal Enclosure, U.S. Pat. No. 4,586,463 which issued to Braeuner on May 6, 1986 for a Bird Cage, U.S. Pat. No. 5,156,640 which issued to Del Rosario on Oct. 20, 1992 for a Bird Cage with Conveyor for Disposing of Debris, U.S. Pat. No. 5,957,086 which issued to Gallardo on Sep. 28, 1999 for a Bird Cage, U.S. Pat. No. 6,532,900 which issued to Wang on Mar. 18, 2003 for a Cleaning Device for Cleaning Pet Excrement, U.S. Pat. No. 6,715,445 which issued to Plante et al. on Apr. 6, 2004 for a Bird Cage, and U.S. Pat. No. 7,114,464 issued to Chang on Oct. 3, 2006 for a Cage.

### SUMMARY OF THE INVENTION

In summary the birdcage according to one aspect of the present invention may characterized in one aspect as including an upper cage for containing at least one bird in captivity and a base portion mounted to the bottom of the upper cage, wherein the cage may be a wire mesh cage or such other material allowing for observation of a bird in the cage while containing the bird from escape from the cage. The base portion may include a removable ball containing a cartridge or tray in which the balls are permanently encased. The cartridge is positionable in the base portion below the upper cage so as to capture on the balls in the cartridge bird excrement or other detritus falling from the upper cage onto the cartridge in the base portion. The cartridge may be removed from the base portion for disposal of such waste by merely the shaking of the cartridge and its balls to remove most of the waste from the balls. The cartridge may be filled with the balls. The balls may be small decorative balls. The balls are intended to also camouflage the excrement and other detritus falling from the birds in the cage. The detritus is intended to fall onto the balls, and to be shook from the balls once the cartridge is removed for cleaning. A tray may form the bottom of the cartridge or may be mountable thereto.

The plurality of balls is of sufficient number so as to substantially fill the cartridge. The plurality of balls may be each no greater in size than substantially the size of a ping-pong ball for example, or in larger cages the plurality of balls may be each no greater than substantially the size of a tennis ball. In some embodiments, the balls are themselves perforated.

### BRIEF DESCRIPTION OF THE DRAWINGS

FIG. 1 is one embodiment of the birdcage according to the present invention showing a ball encasing cartridge in an exploded perspective view.

FIG. 2 is the birdcage of FIG. 1 having a solid tray forming a base under the ball-containing cartridge, again showing the cartridge in an exploded, perspective view.

FIG. 3 is, in unexploded view, the birdcage of FIG. 2.

FIG. 4 is, in partially cutaway view, the birdcage of FIG. 3, with the sides of the ball-containing cartridge partially cutaway to show the balls along the line 4-4 in FIG. 2.

FIG. 5 is, in perspective view, an alternative embodiment of the birdcage according to the present invention, with the ball-containing trays partly slid out.

### DETAILED DESCRIPTION OF EMBODIMENTS OF THE INVENTION

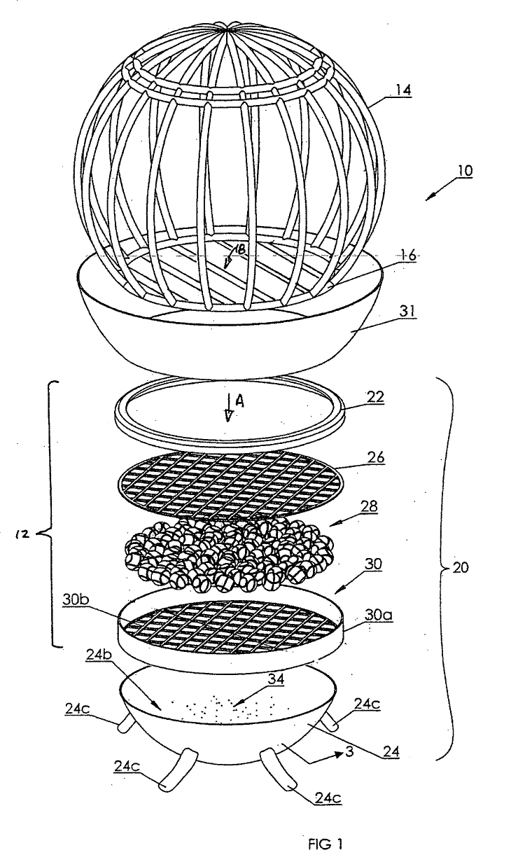

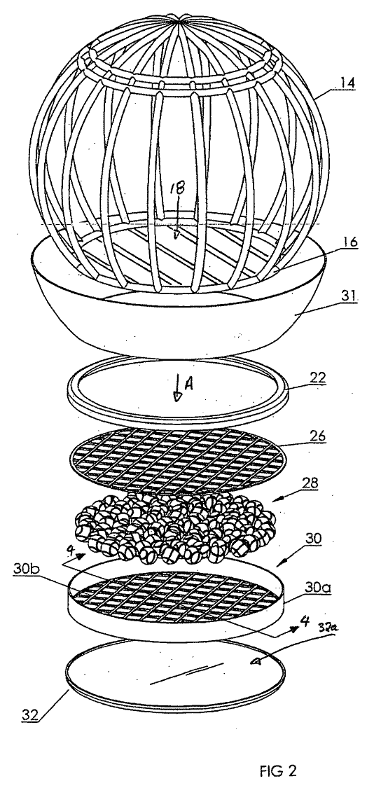

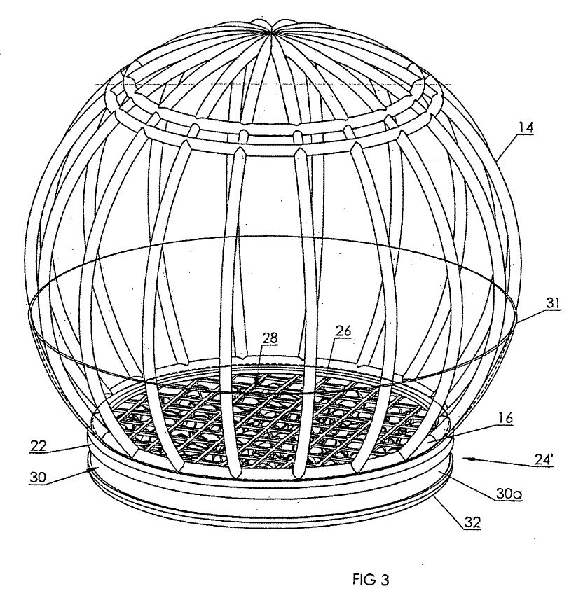

In the embodiments of FIGS. 1-4, the birdcage 10 includes an upper cage portion 14 having a lower annular rim 16 defining an opening in which is mounted a screen floor 18. The rim mounts or otherwise fits or clamps onto or into cooperating registry with, a base portion 20. Base portion 20 comprises a ball-encasing container 12 such as a tray or cartridge or the like which itself may include, by way of example, ring 22 which snugly mates onto the upper rim of tray 30 so as to sandwich therebetween screen 26 and balls 28. Tray 30 includes annular sidewall 30a surrounding circular perforated screen 30b. Ring 22, screen 26, and tray 30 form a permanent cartridge encasing balls 28. Tray 30 may be releasably mounted under floor 18, for example, to rim 16 by which releasable latches or other releasable fasteners (not shown) as known in the art. Tray 30 may mount onto a base container 24 which may be stabilized by feet 24c, as one example, or onto other bases or base containers or base trays to capture waste falling from or through the balls and screens.

Preferably balls 28 are perforated, but smooth sided balls for example similar to ping-pong balls, will also work. A sufficient number of balls 28 are placed in tray 30 so as to substantially completely fill the tray. Excrement and other detritus 34 falling downwardly in direction A from upper cage portion 14 through screen floor 18 as a result of caging a bird (not shown) in birdcage 10, may land on one or more of the plurality of balls 28 or may fall through balls 28 onto the base, for example surface 24b of base container 24, the waste caught on balls 28 may self-clean in the sense of shaking off due to the movement of the cage by the birds, or may be lightly tapped free by light shaking or removal and tapping of the cartridge against a rigid surface. Balls 28 may be typically decorative and serve to camouflage the detritus falling into the base containers or trays such as surface 24b of container 24 or surface 32a of tray 32. Detritus 34 which lands on balls 28 may be easily dislodged by merely shaking or agitating of balls 28 so as to drop detritus 34 down. Surface 24b or surface 32a remains hidden by balls 28 while awaiting cleaning.

Once the excrement dries, or before that if desired, base container 24 or base tray 32, and ball-encasing container 12 may be removed from under the cage portion 14, and balls 28 then shook and surface 24b or 32a respectively easily cleaned. Of course balls 28 may also be cleaned if the excrement is still wet or moist and thus has not shaken free.

A collar 31, which may be transparent or translucent, or opaque, fits around the lower end of the cage 14, for example flush against the cage walls or mesh or bars so as to extend upwardly from rim 16. Collar 31 provides a removable shield which directs detritus 34, such as waste, seeds, etc. back down through floor 18.

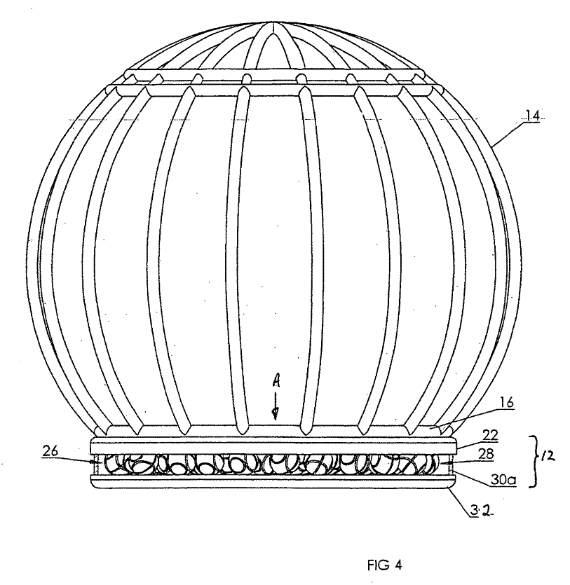

Although in the embodiment best seen in FIG. 4, a single layer of balls 28 is trapped between the upper and lower screens 26 and 30b, it is understood that sides 30a may be higher than illustrated, or the balls smaller so as to accommodate more than a single layer of balls 28. The balls are not necessarily trapped tightly between the upper and lower screens.

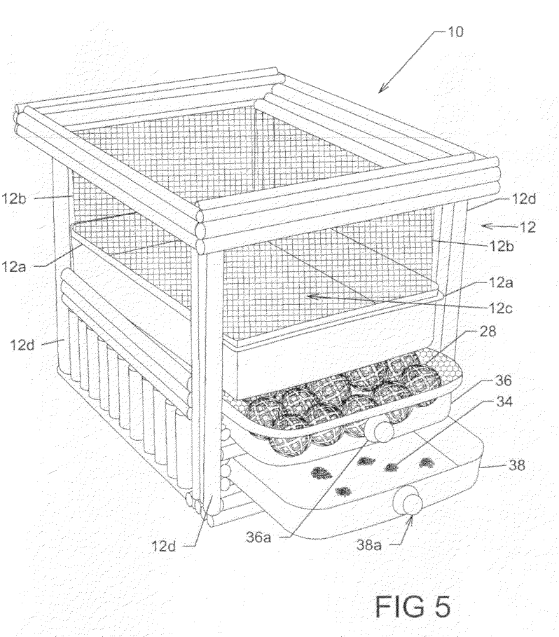

As seen in FIG. 5, birdcage 10 may include an open-topped cage 12 such as may be used for birds which have had their wings clipped. Alternatively, cage 12 may be enclosed in the manner of upper cage portion 14. A wall 12a may enclose the lower portion of cage 12 to inhibit excrement or other detritus from leaving the case through the mesh of the cage sidewalls 12b.

The bottom 12c of cage 12 may be open or may be screened or may be apertured so long as it allows detritus 34 to fall downwardly from cage 12 into drawer or tray 36. Tray 36 encases a plurality of balls 28. The cover and floor of tray 36 are screen, mesh or the like to allow detritus 34 to fall through into the lower drawer or tray 38. Trays 36 and 38 are slidably mounted in support frame 12d underneath cage 12 so as to be removable by a user pulling on handles or pulls 36a and 38a respectively. Tray 36 may thus be agitated to shake the detritus from balls 28, or removed to clean the balls, for example by running the cartridge under tap water. Tray 38 may thus be removed for emptying and cleaning. Again, balls 28 serve to provide a decorative, easily cleaned floor treatment hiding the repository of the bird excrement and other detritus.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A birdcage comprising
a cage portion having a top and a bottom and a mid-portion extending therebetween,
a base portion mounted directly under said bottom, said base portion having an upwardly exposed inner surface, upwardly exposed to said cage portion above it,
a container having upper and lower opposite apertured screens, said container encasing a plurality of balls, said container resting on said base portion,
wherein said plurality of balls is of sufficient number so as to substantially entirely cover over said lower apertured screen of said container and so as to substantially fill said container.

2. The birdcage of claim 1 wherein said balls in said plurality of balls are each no greater than substantially the size of a ping-pong ball.

3. The birdcage of claim 1 wherein said balls in said plurality of balls are each no greater than substantially the size of a tennis ball.

4. The birdcage of claim 2 wherein said container is filled with said plurality of balls to a depth of at least substantially one layer of said balls.

5. The birdcage of claim 1 wherein said base portion includes at least removable tray and wherein said container is mounted for removable sliding above said tray.
